(19) United States
(12) Patent Application Publication
(10) Pub. No.: US 2025/0262998 A1
(43) Pub. Date: Aug. 21, 2025

(54) CAR SEAT AND STEERING WHEEL COVER

(71) Applicant: Ralph SATTERFIELD, Redondo Beach, CA (US)

(72) Inventor: Ralph SATTERFIELD, Redondo Beach, CA (US)

(21) Appl. No.: 18/582,341

(22) Filed: Feb. 20, 2024

(51) Int. Cl. B60N 2/60

(52) U.S. Cl. CPC B60N 2/6009; B60N 2/6027; B60N 2/6036

(57) ABSTRACT

A car seat and steering wheel cover. The car seat and steering wheel cover is formed of a main body configured to prevent rays from the sun from contacting at least one car seat and a steering wheel cover member configured to encompass a steering wheel along with a car seat strap which when attached to the steering wheel and car seat prevent rays from the sun from contacting the steering wheel and car seat. The car seat and steering wheel cover may also cover the driver and passenger seat.

### FIELD OF THE INVENTION

The embodiments of the present invention relate to a cover for a car seat and steering wheel to prevent each from becoming overheated due to exposure to the sun.

### BACKGROUND OF THE INVENTION

KJK Car seat covers are ubiquitous in locations like the Southwestern United States and other hot regions. Conventional car seat covers are designed to block the sun's rays from directly contacting the car seat such that the seat does not overheat. At a minimum, an overheated car seat is uncomfortable for the person sitting in it but it can also cause injury in the form of burns. The same can be said for overheated steering wheels and consoles.

Typically, a car seat is fabricated of a cloth (e.g., canvas) and/or reflective material. In most instances the car seat covers are designed to cover the individual car seats only. In other instances, a window shade is used to keep the sun's rays from contacting any portion of the car interior. Despite the available car seat cover designs, car seat covers suffer many drawbacks including limited coverage and difficult use.

Thus, there exists a need for an improved car seat cover which overcomes the shortcomings associated with current car seat covers.

### BRIEF SUMMARY OF THE INVENTION

Accordingly, a first embodiment of the present invention is a car seat and steering wheel cover fabricated of a flexible material comprising: a main body configured to prevent rays from the sun from contacting at least one car seat; a steering wheel cover member extending from, and separate from, said main body and configured to encompass a steering wheel and prevent rays from the sun from contacting a steering wheel; a strap member extending from said main body opposite said steering wheel cover member and configured to removably attach to a car seat head rest; and wherein when in position said main body is supported by said steering wheel and car seat head rest such that the main body hangs over at least a bottom rest and back rest of said car seat.

A second embodiment of the present invention is a car seat and steering wheel cover fabricated of a flexible material comprising: a main body; a steering wheel member attached to said main body, said steering wheel member in the form of a hood having an opening circumscribed by a stretchable member to attach said steering wheel member to a steering wheel such that said steering wheel member encompasses said steering wheel; a strap attached to said main body and configured to attach to a car seat; and wherein when in position said main body hangs over at least a bottom rest and back rest of said car seat.

A third embodiment of the present invention is a car seat and steering wheel cover fabricated of a flexible material comprising: a main body; a steering wheel member attached to said main body, said steering wheel member in the form of a hood having an opening circumscribed by a stretchable member to attach said steering wheel member to a steering wheel such that said steering wheel member encompasses said steering wheel; a first strap attached to said main body and configured to attach to a driver car seat; a second strap attached to said main body and configured to attach to a passenger car seat; an attachment member configured to retain said main body in an area occupied by said passenger car seat; and wherein when in position said main body hangs over at least a bottom rest and back rest of said driver car seat and passenger car seat.

Other variations, embodiments and features of the present invention will become evident from the following detailed description, drawings and claims.

### BRIEF DESCRIPTION OF DRAWINGS

FIG. 1 illustrates an exemplary car seat;

FIG. 2 illustrates a car seat cover according to the embodiments of the present invention in an open position while not in use;

FIG. 3 illustrates a close up view of the steering wheel cover according to the embodiments of the present invention;

FIG. 4 illustrates a perspective view of the car seat cover from FIG. 2 in place in a vehicle;

FIG. 5 and FIG. 6 illustrate side views of the car seat cover from FIG. 2 in place in a vehicle; and

FIG. 7 illustrates a second embodiment of the present invention in an open position while not in use.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

The embodiments of the present invention are directed to a new and uniquely designed car seat cover. The embodiments of the present invention are described below, in certain instances, relative to specific materials. However, those skilled in the art will understand that other materials may be used to fabricate the car seat cover according to the embodiments of the present invention.

FIG. 1 shows an exemplary car seat 50 of the type which the embodiments of the present invention may be used. The car seat 50 includes a bottom rest 55, back rest 60 and head rest 65. Those skilled in the art will recognize that any car seat having a head rest may be used to support the car seat cover disclosed herein. Car seats without a head rest may also support the car seat cover disclosed herein by modifying the length of the head rest strap to accommodate an upper portion of the car seat.

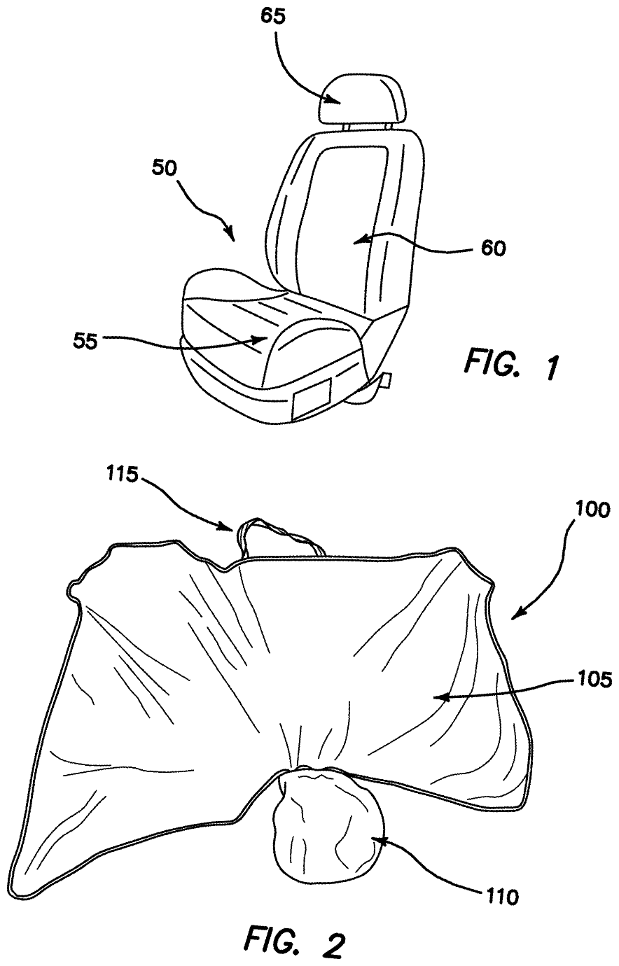

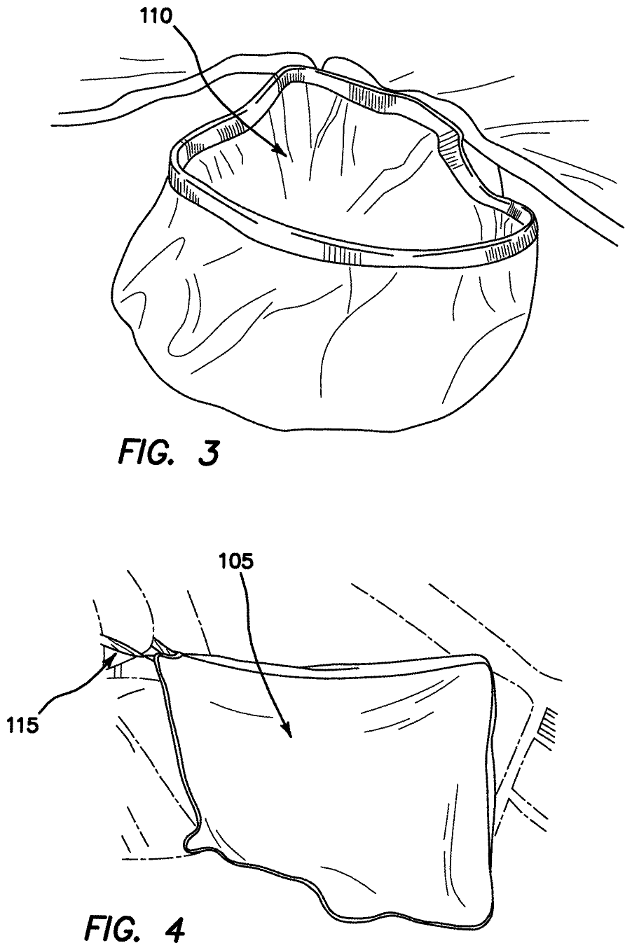

FIG. 2 shows a car seat cover 100 according to the embodiments of the present invention. The car seat cover comprises a main body 105, steering wheel cover member 110 (see FIG. 3) and head rest strap 115. In one embodiment, the car seat cover 100 is fabricated of a breathable, washable, cloth material (e.g., cotton-based materials). However, other materials suitable to interfere with the sun's rays may also be used. In one embodiment, the material may be reflective on an outer surface to further aide in preventing the car seat, steering wheel and adjacent car interior components from being heated by the sun.

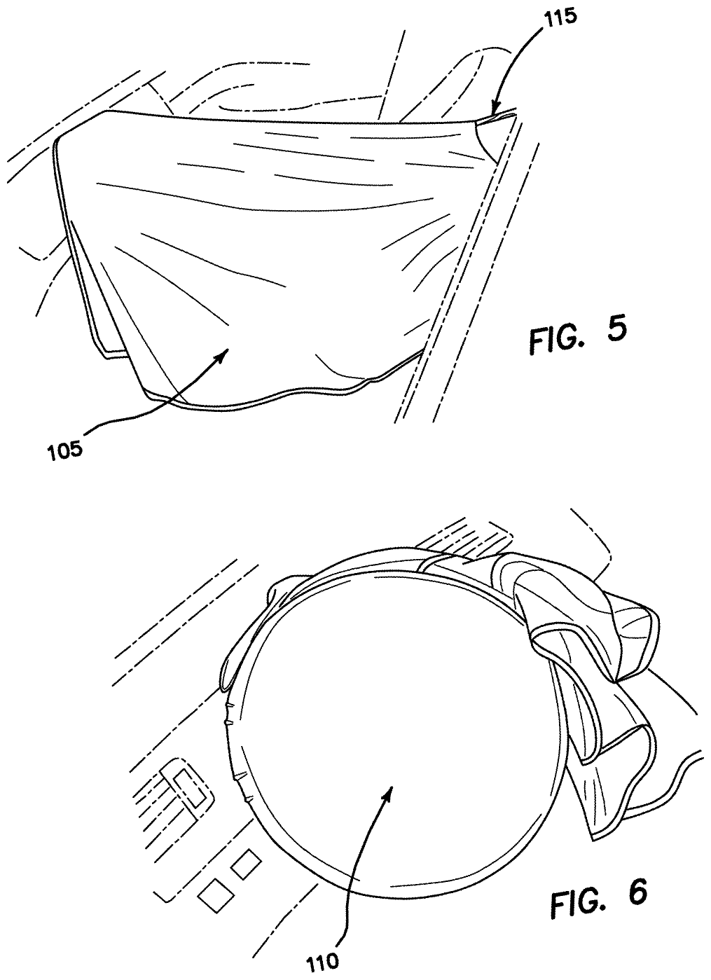

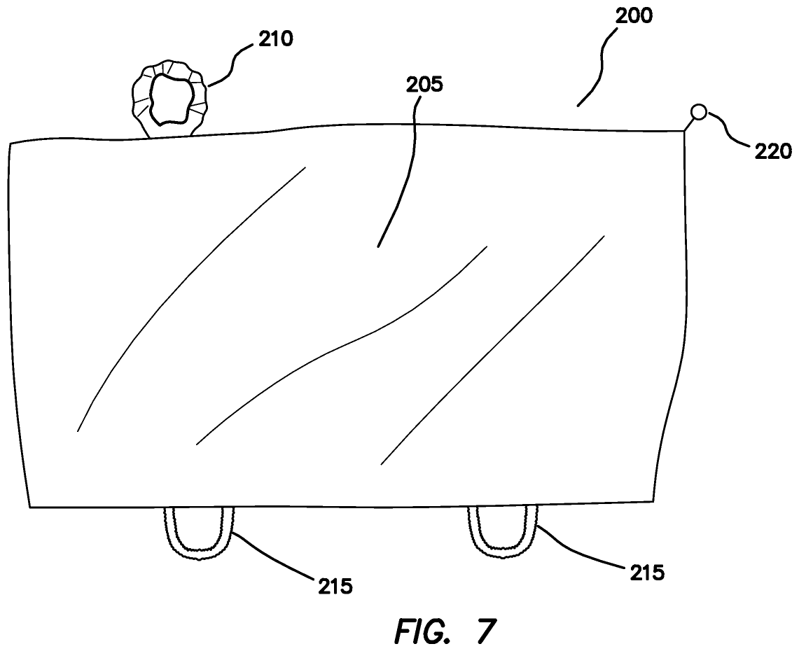

FIGS. 4-6 show the car seat cover 100 in place in a vehicle. Installing the car seat cover 100 comprises attaching the steering wheel cover member 110 to the steering wheel and the head rest strap 115 to the head rest 65. Doing so causes the main body 105 to drape or hang over a bottom rest 55 and back rest 60 which together form a car seat 50. In this manner, the main body 105 shades the car seat 50 from the sun, regardless of the sun's position in the sky.

In one embodiment, the steering wheel cover member 110 is configured in the form of a hood having an opening circumscribed by a strip of stretchable material 125 (e.g., elastic). As shown, the elastic material is sewn within the material. The elastic strip 125 provides an adjustable steering wheel cover member 110 which fits over multiple-sized steering wheels. Moreover, the hood wraps around the entirety of the steering wheel thereby securely maintaining the car seat cover 100 in place. In one embodiment, the steering wheel cover member 110 is sewn to the main body 105. Those skilled in the art will recognize that other attachment means may be used or the main body 105 and the steering wheel cover member 110 may be fabricated of a single piece of material.

In one embodiment, the head rest strap 115 is elastic wrapped in the material. The elastic head rest strap 11S allows the head rest strap 115 to accommodate multiple-sized head rests. In one embodiment, the elastic head rest strap 115 is sewn to the main body 105.

In another embodiment, as shown in FIG. 7, a car seat cover 200 is configured to cover both car seats of a vehicle. The car seat cover 200 includes a main body 205, steering wheel cover member 210 and a pair of head rest straps 215. To ensure the main body 205 covers both car seats, the main body 205 includes a hook, suction cup or other attachment member 220 (shown as a suction cup) for attaching or retaining the main body to the passenger window, passenger door panel, dashboard or glove box such that a portion of the main body 205 remains in an area occupied by the passenger car seat. While the attachment member 220 is shown on the corner of the main body 205, the attachment member 220 may be connected to the main body 205 at any point to allow the main body 205 to cover the passenger seat. The attachment member may be any type of device including, but not limited to, a suction cup, hook, clip, hook and loop fasteners, adhesive, snap, carabiner or weight.

While not shown, the car seat covers described herein are ideal for branding with car company logos, car product logos, team logos and any other logo or brand.

An additional benefit of the car seat cover 100 is that it can be used as an article of apparel. The main body 105 wraps around the user's shoulders, chest and torso. Depending on the weather, the steering wheel cover member 110 may be used as a hood to protect the user's head from rain or the sun's rays.

Although the present invention has been described in detail with reference to several embodiments, additional variations and modifications exist within the scope and spirit of the invention as described and defined in the following claims.

I claim:

1. A car seat and steering wheel cover fabricated of a flexible material comprising:
a main body;
a steering wheel member attached to said main body, said steering wheel member in the form of a hood having an opening circumscribed by a stretchable member to attach said steering wheel member to a steering wheel such that said steering wheel member encompasses said steering wheel;
a first strap attached to said main body and configured to attach to a driver car seat;
a second strap attached to said main body and configured to attach to a passenger car seat;
an attachment member configured to retain said main body in an area occupied by said passenger car seat; and
wherein when in position said main body hangs over at least a bottom rest and back rest of said driver car seat and passenger car seat.

2. The car seat and steering wheel cover of claim 1 wherein said steering wheel cover member is in the form of a hood with a stretchable member circumscribing a hood opening.

3. The car seat and steering wheel cover of claim 1 wherein said flexible material is reflective on at least one surface.

4. The car seat and steering wheel cover of claim 1 wherein said attachment member is one of the following:
a) a suction cup;
b) a hook;
c) a clip;
d) hook and loop fasteners;
e) adhesive;
f) snap;
g) carabiner; or
h) weight.
